(19) United States
(12) Patent Application Publication
(10) Pub. No.: US 2004/0159977 A1
(43) Pub. Date: Aug. 19, 2004

(54) Method and apparatus for applying a decorative pattern to a surface

(76) Inventors: Robert S. Perfetto, Charlotte, NC (US); Kenneth M. Maloy, Bessemer City, NC (US)

Correspondence Address: SMITH MOORE LLP, P.O. BOX 21927, GREENSBORO, NC, 27420, US

(21) Appl. No.: 10/368,664

(22) Filed: Feb. 18, 2003

(51) Int. Cl. B29C 59/04

(52) U.S. Cl. 264/293; 425/363; 425/385

(57) ABSTRACT

An apparatus for applying a decorative design to a surface comprising a roll having an outer cylindrically shaped surface formed of an engravable material, such as rubber, and a pattern that is partially engraved into the engravable material on the roll such that the pattern is raised on the outer surface of the roll. The pattern is either close-ended or open-ended on both ends of the roll. When the roll is rolled over a surface in parallel and abutting and/or partially overlapping rows, the pattern is transferred in ghost onto the surface and there is no discernable line or seam between the parallel and abutting and/or partially overlapping rows.

### BACKGROUND OF THE INVENTION

The present invention relates to faux finishing, and more particularly, to a method and apparatus for applying faux finish designs to a variety of surfaces such as sheetrock, wood, plaster, concrete, and stucco.

Faux finishing is the art of creating illusions on a variety of surfaces. There are numerous combinations of colors, tools, and techniques that can be used to create a multi-colored and textured appearance that is aesthetically pleasing. Interior walls in a home or building, for example, may be finished to look and feel like expensive wallpaper in color and texture. Also, concrete patios and sidewalks, for example, may be finished to resemble natural stone in color and texture.

The creation of faux finishes and other decorative treatments on surfaces has been achieved by a variety of prior art methods and apparatuses. These prior art applications, however, are either burdensomely time consuming and labor intensive or the techniques for applying the finish are messy, inconsistent, and inaccurate. Furthermore, the prior art tools used to create faux finishes require constant maintenance during the application process.

For example, some popular prior art methods for applying a faux finish to interior walls are sponge painting, crackle finishing, and foam pattern rolling. Sponge painting is a method of achieving a mottled finish by applying a dark shade of base coat paint onto a surface and allowing it to dry. A sponge is then dipped into a lighter second paint color and wrung to release the excess paint. The sponge is then lightly dabbed onto the surface to transfer a subtle image on top of the base color of paint on the wall. The sponge is continuously dabbed on the surface in an overlapping and random pattern until no more paint transfers onto the wall from the sponge. The process is then repeated until the wall is covered with the pattern.

The sponge painting process has several disadvantages. First, the process is very messy as the painter must continuously dip the sponge in the paint and wring it out. Excess paint on the painter's hands must be continuously removed to avoid unintended contact with the wall. Further, uniform pressure must be applied to the sponge as it is dabbed on the wall to avoid over impressions or underimpressions on the wall. Similarly, as the sponge is dabbed across the wall, the image becomes lighter as the paint on the sponge is exhausted. This causes the resulting finish on the wall to include a combination of dark and light images, which gives an inconsistent appearance on the surface. Finally, this process is fatiguing and time consuming because the sponge is dipped into the paint hundreds of times during a typical application.

A second type of interior finishing is crackle finishing. This is a three dimensional finish that is achieved by rolling a dark shade base color paint onto a surface and allowing it to dry. White glue is then applied to the surface with a paintbrush and the glue is dried until it is tacky to touch. A lighter color base coat is then applied over the base coat. The surface randomly pulls apart and “crackles” within a few minutes of applying the second coat.

A disadvantage of crackle finishing is that the application of the glue to the wall is messy. Also, the glue sags as it is applied to the wall and the paintbrush tends to drag the glue as it is brushed across the surface. Further, the painter must accurately determine when the glue is tacky so that the second coat may be applied. If the glue is too dry, the paint covers the glue without crackling. Even under ideal conditions, the paint must be applied quickly in one pass to avoid pulling the paint away from the surface or the paint coagulating on the surface. Also, the crackled surface is sensitive to humidity so a protective varnish must be applied to the surface to prevent deterioration of the finish.

Another type of interior faux finishing is foam pattern rolling. Foam pattern rolling is similar to conventional paint rolling using a standard L-frame roller. However, the roller has a raised foam pattern on the roller's surface rather than a traditional nap surface. The pattern may be in the shape of leaves or flowers, for example. The roller is dipped into a paint tray to saturate the raised pattern with paint and the pattern is transferred onto the surface as the roller is applied to the wall. When the pattern become lighter than desired, the roller is reloaded with paint and the process is repeated.

Similar to the disadvantages of sponge painting, if the foam pattern roller is over-saturated with paint, the image on the surface is blotchy. On the other hand, if the roller is undersaturated with paint, the image is too light. Thus, the resulting wall is a combination of over impressions and under impressions giving an inconsistent appearance to the surface. Likewise, an inconsistent appearance occurs if uneven pressure is applied as the roller is moved across the wall surface and as the paint on the roller becomes exhausted.

Some popular prior art methods for applying a faux finish to concrete include stamping and rolling a pattern into uncured concrete. A pattern such as brick or stone may be stamped into concrete by first pouring the concrete into a conventional form for a walkway, patio, pool deck, or driveway, for example. After applying a releasing agent to the surface, textured 24-inch square plates are placed tightly together on the surface and tamped into the concrete. The stamps are then removed from the concrete and placed precisely on the edge of the impression of the previous row and tamped into place. This process is completed until the design is complete.

The stamping process is very time-consuming because each 24 inch patterned square must be individually placed in the concrete, tamped, and then repositioned in the next row. All of this must be done while the concrete is still malleable. It is also difficult to achieve a level design. The stamps must be perfectly square and placed tightly to achieve a uniform, square, and centered design. Inconsistent tamping results in inconsistent depth of the design and one edge of the design may not be parallel with the opposite side. Further, if the stamps are not placed tightly together, the pattern mortar joints overlap giving the design an inconsistent appearance.

A faux pattern such as brick or stone may be rolled into concrete with a patterned roller attached to the yoke of an elongated handle, such as the one disclosed in U.S. Pat. No. 5,033,906. The roller disclosed in the patent includes a close-ended/open-ended design. Particularly, the pattern is close-ended on the end of the roll where the pattern is complete, meaning that the pattern is not altered or cropped to fit the roll. The pattern is open-ended on the end of the roll where the pattern is incomplete, meaning that the pattern is cropped and/or left open. The roller is used to create an impression in concrete by pouring the concrete into a conventional form. One-millimeter thick synthetic flexible film sheets are spread over the entire surface to allow the roller to be pulled over the concrete surface. A chalk line is drawn on the film sheets to guide the roller as it is pulled across the surface. The roller is rolled across the surface with the open-end design facing the next row of the unrolled concrete surface. The roller is picked-up, moved to the starting point of the next row, placed perpendicular to the chalk line, and rolled along the line with the close-ended side completing the pattern of the prior row's open-ended side. The process is repeated until the design is complete.

Great skill and accuracy must be used when applying a faux finish to concrete with a roller as described above because if the roller is guided off of the chalk line, the resulting pattern is misaligned and distorted. Regardless of any misalignment, there is always a repeating straight line or noticeable seam in the pattern from the closed-end of the roller. Also, when the flexible film sheets that are used to cover the concrete surface are removed, the concrete has a tendency to lift away from the surface. The roller generally weighs about 60 pounds so its use requires significant strength and endurance to lift the roll from the end of a completed row to the beginning of the next row. The weight of the roller also prohibits it from being used on a vertical surface such as an exterior wall. Finally, prior art concrete rollers do not include halftone screen textured finishes.

Accordingly, there is a need in the art for an improved method and apparatus for applying a faux finish to interior and exterior walls and concrete surfaces that is less messy and labor-intensive, and requires less skill and accuracy on part of the user.

### SUMMARY OF THE INVENTION

The present invention provides an apparatus for applying a decorative design to a surface including a roll having an outer cylindrically shaped surface formed of an engravable material, such as rubber, and a pattern that is partially engraved into the engravable material on the roll such that the pattern is raised on the outer surface of the roll. The pattern is either open-ended or close-ended on both ends of the roll such that when the roll is rolled over a surface in parallel and abutting and/or partially overlapping rows, the pattern is transferred in ghost onto the surface and there is no discernable line or seam between the parallel and abutting and/or partially overlapping rows. In a preferred embodiment, the pattern is laser engraved into the roll. The rubber on the surface of the roll is preferably about 1/16″ to 1″ thick and has a shore hardness between about 30 and 85. Also, the roll preferably includes an inner tube formed of phenolic paper or fiberglass.

The pattern is preferably engraved into the roll about 1/32″ to 1″ deep and may include additional engraved portions within the pattern to form a three-dimensional engraved pattern. The edges of the pattern are preferably engraved into the roll at an angle that is less than 90 degrees. The pattern may be engraved with a plurality of dots to create a halftone screen effect wherein the dots vary in size and position within the pattern. The pattern may also be decorative, such as a brick, stone, flower, or leaf design.

The roll of the present invention may be applied to a surface selected from the group consisting of, but not limited to, sheetrock, wood, plaster, stucco, and concrete. Also, the roll may be rolled over a surface that is painted or glazed.

The present invention also provides an apparatus for applying a decorative design to a surface including a first roll having an outer cylindrically shaped surface formed of rubber and a first pattern that is partially engraved into the rubber on the first roll such that the first pattern is raised on the outer surface of the first roll and is either open-ended or close-ended on both ends of the roll. Also provided is a second roll having an outer cylindrically shaped surface formed of rubber and a second pattern that is partially engraved into the rubber on the second roll such that the second pattern is raised on the outer surface of the second roll, is either open-ended or close-ended on both ends of the roll, and is orthogonal to the first pattern on the first roll. Thus, when the first roll is rolled onto a painted or glazed surface in a first direction, the first pattern is transferred in ghost onto the surface. When the second roll is rolled onto a painted or glazed surface in a second direction that is perpendicular to the first direction and abuts and/or partially overlaps the image created by the first roll, the second pattern is transferred in ghost onto the surface and there is no discernable line or seam between the images formed by the perpendicular and abutting and/or partially overlapping rows formed by the first roll and the second roll.

A method of applying a decorative pattern to a surface is also provided. The method includes the steps of providing a roll having an outer cylindrically shaped surface formed of rubber, the roll having a pattern that is partially engraved into the rubber on the roll such that the pattern is raised on the outer surface of the roll and is either open-ended or close-ended on both ends of the roll, and rolling the roll onto a surface in parallel and abutting and/or partially overlapping rows such that the pattern is transferred in ghost onto the surface and there is no discernable line or seam between the parallel and abutting and/or partially overlapping rows. The method further includes the steps of loading the roll onto a paint applicator including a handle such that the roll is rotatable on the paint applicator and loading the roll onto a cylinder including a handle such that the roll is rotatable on the cylinder.

### BRIEF DESCRIPTION OF THE FIGURES

The present invention is better understood by a reading of the Detailed Description of the Preferred Embodiments along with a review of the drawings, in which:

FIG. 1 is a perspective view of a rubber roll having an engraved faux brick design in accordance present invention.

FIG. 2 is a perspective view of an unengraved rubber roll in accordance with the present invention.

FIG. 3 is a perspective view of a rubber roll with an engraved faux natural stone pattern in accordance with the present invention.

FIG. 4 is a perspective view of a rubber roll with an engraved flower pattern in accordance with the present invention.

FIG. 5 is a perspective view of a rubber roll with an engraved 3-dimensional design in accordance with the present invention.

FIG. 6 is a perspective view of a rubber roll with an engraved logo in accordance with the present invention.

FIG. 7 is an enlarged view of a rubber toll with an engraved halftone screen floral pattern.

FIG. 8 is a front view of a rubber roll with an engraved stripe pattern and its corresponding orthogonal roll in accordance with the present invention.

### DETAILED DESCRIPTION OF THE PREFERRED EMBODIMENTS

The illustrations and examples discussed in the following description are provided for the purposes of describing the preferred embodiments of the invention and are not intended to limit the invention thereto.

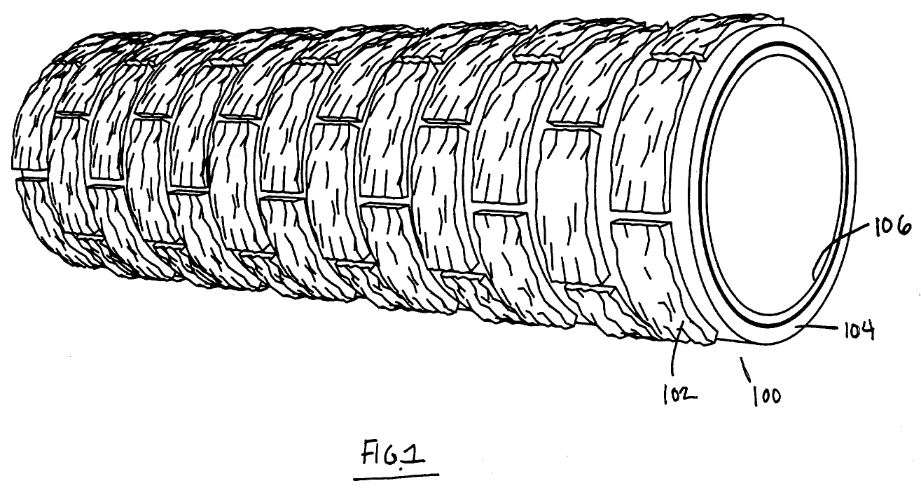

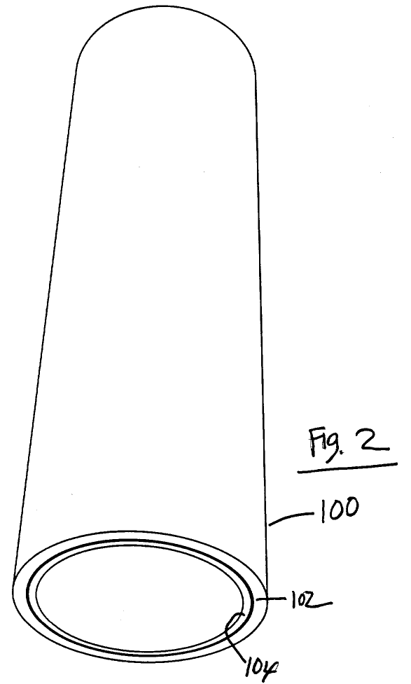

As shown in FIG. 1, the apparatus for applying a faux finish to surfaces such as interior walls, exterior walls, and concrete comprises a rubber cylinder 100 with a faux pattern 102 cut in relief, meaning that the image is raised. In one embodiment, particularly where the roll 100 is intended for use on interior walls, the roll 100 may be formed by injection molding or by wrapping a polymeric compound, such as a continuous sheet of rubber 104, around a phenolic impregnated paper tube 106, as shown in FIG. 2. In another embodiment, particularly where the roll 100 is intended for use on exterior walls and concrete surfaces, the roll may be formed by injection molding or by wrapping a polymeric compound around a fiberglass tube. It should be understood that the roll 100 of the present invention is not limited to having an inner tube formed of phenolic paper of fiberglass. Rather, various types of materials may be used for the inner tube.

The durometer and type of polymeric compound that is used to create the rubber roll 100 is also selected to optimize the anticipated application of the rubber roll 100. Durometer is a measure of hardness of the material. The lower the durometer, the softer the material is. Polymers such as ethylene and propylene, with a shore hardness of 30-45, are best suited to displace fluid materials, such as paint or liquid glazing materials, that are generally used on interior walls. A polymer such as carboxylated nitrile, with a shore hardness of 75-85, is best suited to displace more viscous materials such as concrete and plaster or stucco used on exterior walls.

The sheet of rubber 104 that is wrapped around the phenolic paper or fiberglass tube 106 is relatively thin so it is wound around the tube 106 numerous times to achieve a desired thickness of rubber on the tube 106. Preferably, the total thickness of rubber on the tube 106 is about 1/16 to 1 inch. The rubber is then cured in a dry-cure autoclave, for example, at a temperature of about 180° with 60 psi. The heat and pressure fuses and cross links the layers of rubber so that a master rubber roll 100 is formed. The surface of the master rubber roll 100 is then cylindrically ground to form a smooth, seamless rubber roll. The seamless master rubber roll 100 may be cut to form a plurality of rolls 100 that are about twelve inches long, which is the length of a conventional paint roller.

In a preferred embodiment, digitized designs are engraved into the rubber roll 100 with direct laser ablation, which removes the relief area by laser energy to form the pattern 102. In particular, a desired pattern or image may be loaded into a computer that controls the laser. Such designs may include bricks, natural stones, flowers, leaves, etc., as shown in FIGS. 1 and 3-6. The rubber roll 100 is mounted into the laser engraver and the downloaded image is etched into the roll 100 as it cylindrically turns in the engraver. A typical engraved design 102 may be from about 1/32 to 1 inch deep. In a preferred embodiment, the engraved design 102 is only partially engraved into the roll 100 such that a portion of the rubber 104 is still exposed in the recessed areas of the design 102. It is also preferred that the design 102 is engraved into the roll 100 by cutting a shoulder into the rubber at an angle of about 30°, 45°, or 60°, rather than a 90° angle. This enables the roll 100 to produce more crisp lines when the pattern is transferred onto a surface because excess material, such as paint, cement, or stucco does not get caught in the recesses of the roll 100 and ultimately seep on the surface to distort the image. Rather, the excess material simply flows down the angle of the shoulder.

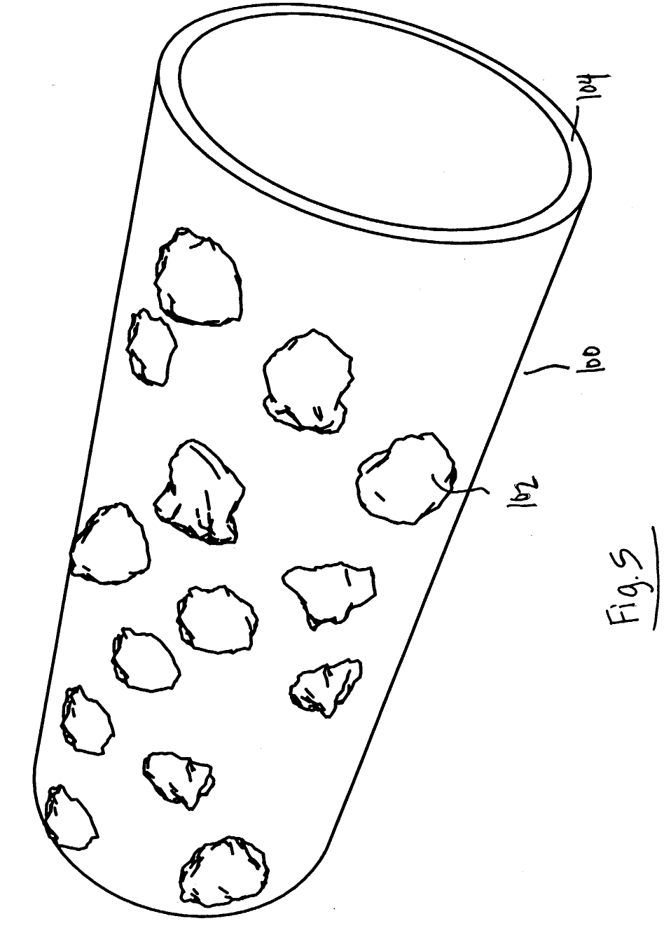

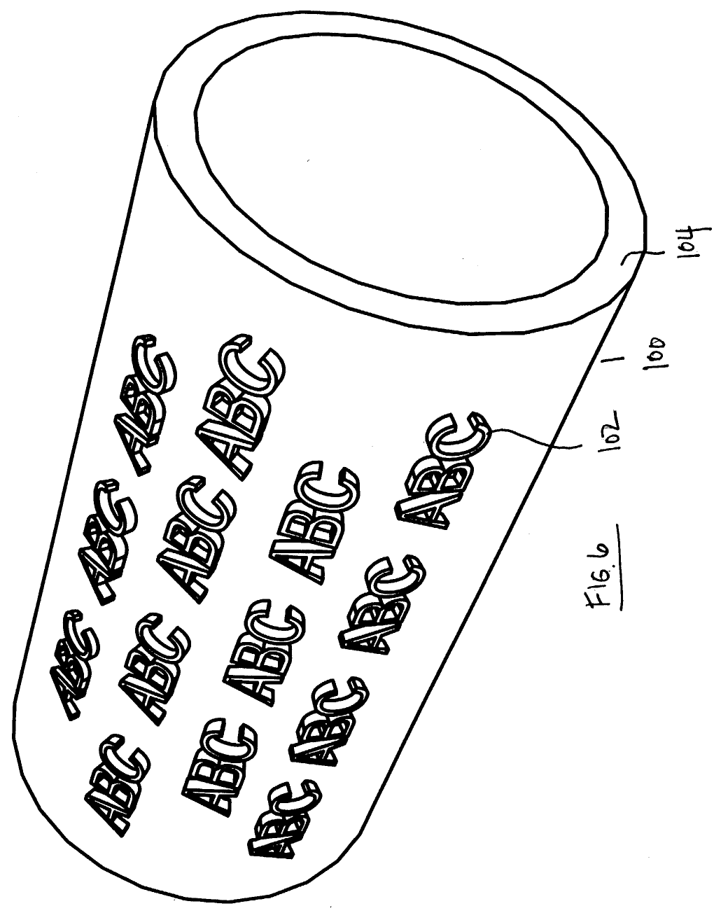

The precision and speed of the laser engraving process can be used to economically engrave an infinite number of patterns 102 into a roll 100. Also, the patterns 102 that may be formed are in sharp contrast to the rudimentary and limited patterns available in the prior art. For example, unlike prior art apparatuses for applying a faux finish to a surface, the roll 100 of the present invention may be engraved with a three-dimensional pattern 102 to achieve a more aesthetically pleasing design on the surface on which the pattern is applied. Particularly, in addition to the pattern 102 being cut in relief on the rubber roll 100, the pattern 102 itself may have three-dimensional depth and contours, as shown in FIG. 5. Such three-dimensional patterns 102 may be applied to plaster on an interior wall, stucco on an exterior wall, or concrete on an exterior flat surface, for example. Also, customized two-dimensional and three-dimensional designs may be laser engraved into the rubber roll 100, such as logos or other unique designs, as shown in FIG. 6.

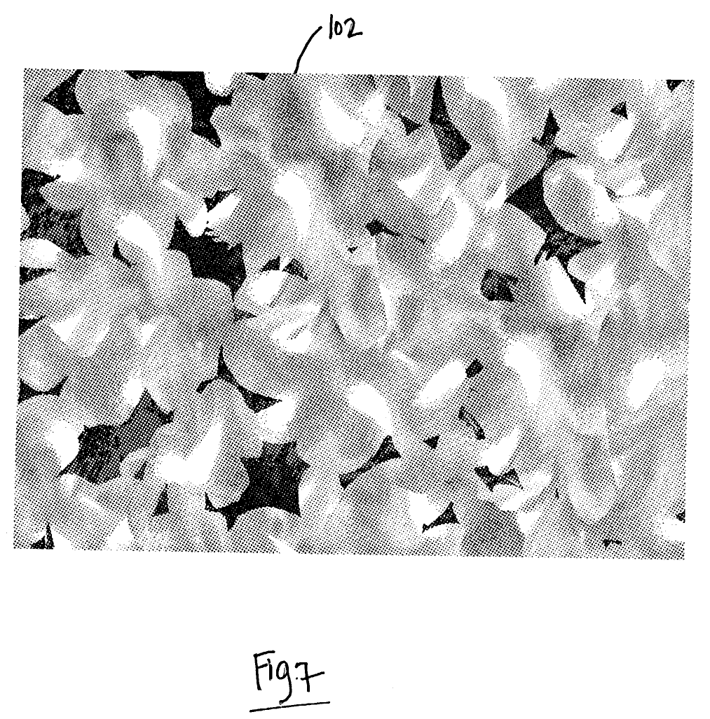

Further, unlike prior art apparatuses, the roll 100 of the present invention may be engraved to achieve a halftone screen effect in the desired pattern. In the printing industry, halftone screening is used to simulate various shades and tones through the use of a process called dithering, wherein the density of a plurality of black dots is varied to simulate various shades of gray. For example, a group of large dots placed closely together appears black, a group of smaller dots with larger spaces between them produces a weaker, gray shade, and a group of even smaller dots spaced widely apart appears almost white. The roll 100 of the present invention may be engraved with an image having a plurality of dots of varying size and in varying positions to create an image on a surface having varying depths and intensities of color, as shown in the floral pattern of FIG. 7. In a preferred embodiment, the dots are engraved into the roll 100 at various angles.

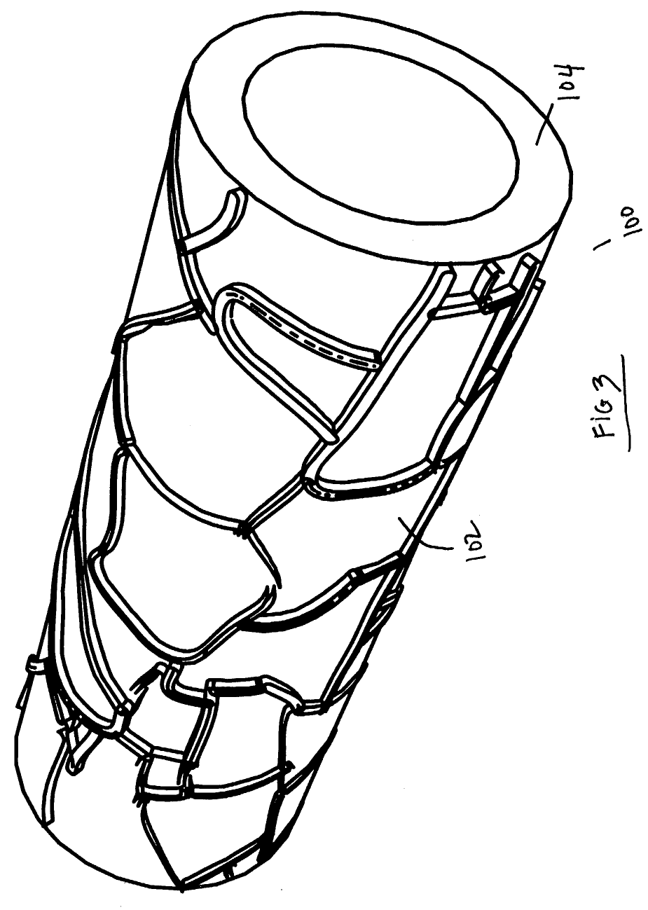

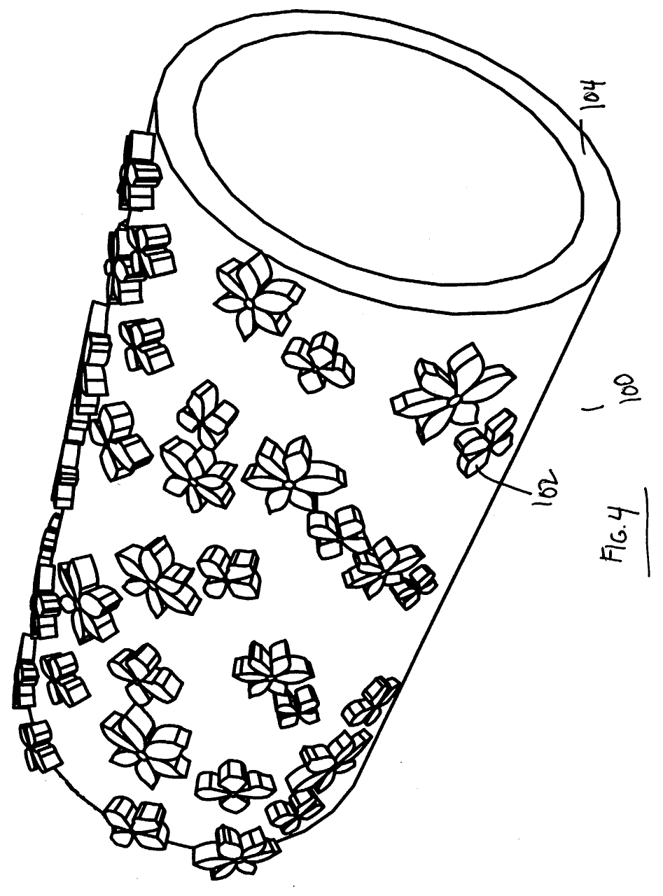

An additional advantage of using the laser engraved rubber roll 100 of the present invention to create a faux finish is that a seamless pattern may be created on the surface of interior walls, exterior walls, and concrete. As shown in FIG. 4, the design 102 covers the surface of the roll 100. In this embodiment, the pattern is close-ended on both ends of the roll 100, meaning that the pattern 102 is complete and the petals are not cropped or altered to fit the size of the roll 100. The brick pattern 102 on the roll 100 of FIG. 1 is also close-ended on both ends of the roll 100. In an alternative embodiment, the pattern 102 on the roll 100 may be open-ended on both ends of the roll 100, meaning that the pattern 102 is left open or incomplete, as shown in the stone pattern of FIG. 3. In this embodiment, the open-end of the design on a row formed by the roll 100 is completed by a second adjacent row formed by the roll 100. When the roll 100 is rolled over a freshly painted or glazed surface, for example, in parallel and abutting and/or partially overlapping rows, the roll 100 transfers the pattern in ghost onto the surface. Regardless of whether the roll 100 of the present invention includes a dual close-ended or dual open-ended pattern 102, the roll 100 creates the pattern so that there are no discernable lines or seams between the images formed by the rows. Many typical faux pattern techniques, such as ragging and sponging, can be duplicated by an engraved roll 100, thereby significantly reducing the time and knowledge required to apply the design.

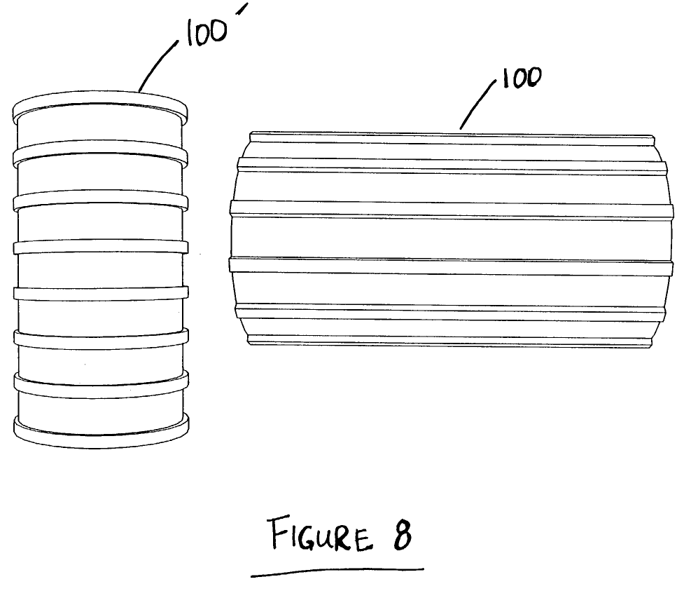

In cases where the surface being treated abuts another surface, such as where a wall abuts a ceiling, an orthogonal engraved rubber roll 100′, as shown in FIG. 8, is provided to treat the areas closest to the joint formed by the abutting surfaces. Particularly, the orthogonal roll 100′ is engraved with the same pattern that is engraved on the first roll 100, except that the pattern on the orthogonal roll 100′ is orthogonal to that of the first roll 100. When applying the rolls 100 and 100′ to a surface, the first roll 100 is applied to the wall in a first direction, such as in a vertical direction on a wall. The painter stops the roll 100 close to the ceiling to prevent unwanted paint from getting on the ceiling. This leaves a gap at the top of the wall. The orthogonal roll 100′ is then rolled horizontally across the top of the wall, close to the ceiling, to fill in the gap. Due to the dual open-ended or dual close-ended pattern on the both ends of the rolls 100, 100′ and the orthogonal pattern on the orthogonal roll 100′, a seamless design is created on the wall from the bottom of the wall to the ceiling. This use of an orthogonal roll 100′ may be applied to corners and other surface areas that are difficult to reach.

The present invention also provides for seamless patterns to be created in cement and stucco. Particularly, the roll 100 of the present invention may be engraved with a brick or stone pattern, for example, as shown in FIGS. 1 and 3. The design 102 creates a pattern when the roll 100 is loaded onto a cylinder and rolled over a freshly poured, uncured concrete or stucco surface in a straight line, perpendicular to the axis of the starting point. The cylinder is placed at the starting point of the next row at the zero point of the cylinder and rolled parallel to the prior row with minimal or no overlapping. The zero point is the starting position of the cylinder as it's moved from row to row. The cylinder is heavier at the starting position so gravity will return it to the zero point when it is lifted from row to row. When the cylinder including the roll 100 is rolled in parallel and abutting and/or partially overlapping rows, no discernable line or seam is created between the images formed by the rolled rows. Thus, faux pattern patterns, such as natural stone or brick, can be duplicated by an engraved roll 100, thereby significantly reducing the time and knowledge required to apply the design.

The method of creating a faux finish on a surface using the apparatus described above is primarily the same for interior surfaces, exterior surfaces, and cement. First, the engraved roll 100 may be loaded onto a conventional paint roller L-frame for ease of use. For interior surfaces, a base coat is applied to the wall being treated. After the base coat dries, a tinted overcoat or glaze is applied to the wall. Before the overcoat dries, it is rolled with the engraved rubber roll 100 of the present invention. The rubber surface of the roll 100 is specifically formulated to be non-absorbent so the relief surface on the rubber roll 100 squeezes the liquid overcoat into the recesses of the roll 100. This leaves the image of the pattern 102 on the roll 100 on the surface in ghost. Particularly, the roll 100 displaces the paint or glaze that has already been applied to the surface, rather than transferring the paint or glaze from the roll to the surface as in prior art methods. Because only the raised surface of the roll 100 contacts the overcoat, the roll 100 does not produce an end-of roll seam in the overcoat, as described above. Also, the image itself is seamless, consistent, and free of streaks. After the surface has been rolled, the tinted overcoat is dried. This process may be repeated with any number overcoats and images.

For concrete and exterior surfaces, such as stucco, the engraved roll 100 is rolled over the uncured concrete and applied stucco while the material is still malleable. Unlike prior art apparatuses, the rubber roll 100 of the present invention is lightweight so it can be easily applied to viscous materials without significant strength or endurance. Similar to interior surfaces, the images are transferred to the surface in ghost and are seamless due to the pattern 102 being cut in relief on the roll 100 and being open-ended on both ends of the roll 100. Unlike the prior art, it is not necessary to use flexible film poly sheets on the treated surface because the polymer compound surface of the roll can be formulated with a release agent.

The apparatus and method of applying a decorative pattern to a surface of the present invention provides a new and unique way for achieving seamless, consistent, and crisp designs without being time-consuming, labor intensive, or requiring a high level of precision or specific training. The apparatus of the present invention is lightweight, easy to use, and is not overwhelmingly messy. Also, the roll 100 can be easily customized to include two-dimensional and three-dimensional patterns. The apparatus of the present invention is easy to manufacture, and is relatively inexpensive to produce.

Certain modifications and improvements will occur to those skilled in the art upon a reading of the forgoing description of the present invention. It should be understood that the invention is not limited to a particular type of engravable material, specific rubber compound, design or use on any particular types of materials or surfaces. All such modifications and improvements of the present invention have been deleted herein for the sake of conciseness and readability but are properly within the scope of the following claims.

What is claimed is:

1. An apparatus for applying a decorative design to a surface comprising:
a roll having an outer cylindrically shaped surface formed of an engravable material; and
a pattern that is partially engraved into the engravable material on the roll such that the pattern is raised on the outer surface of the roll;
wherein when the roll is configured to be rolled over a surface in parallel and abutting and/or partially overlapping rows such that the pattern is transferred in ghost onto the surface and there is no discernable line or seam between the parallel and abutting and/or partially overlapping rows.

2. The apparatus of claim 1 wherein the pattern is open-ended on both ends of the roll.

3. The apparatus of claim 1 wherein the pattern is close-ended on both ends of the roll.

4. The apparatus of claim 1 wherein the pattern is laser engraved into the roll.

5. The method of claim 1 wherein the engravable material is rubber.

6. The apparatus for applying a decorative design to a surface of claim 5 wherein the rubber on the surface of the roll is about 1/16″ to 1″ thick.

7. The apparatus for applying a decorative design to a surface of claim 5 wherein the rubber on the surface of the roll has a shore hardness of about 30-45.

8. The apparatus for applying a decorative design to a surface of claim 5 wherein the rubber on the surface of the roll has a shore hardness of about 75-85.

9. The apparatus for applying a decorative design to a surface of claim 1 wherein the roll further comprises an inner tube formed of phenolic paper.

10. The apparatus for applying a decorative design to a surface of claim 1 wherein the roll further comprises an inner tube formed of fiberglass.

11. The apparatus for applying a decorative design to a surface of claim 1 wherein the pattern is engraved into the roll about 1/32″ to 1″.

12. The apparatus for applying a decorative design to a surface of claim 1 wherein the pattern includes additional engraved portions within the pattern, thereby forming a three-dimensional engraved pattern.

13. The apparatus of claim 1 wherein the edges of the pattern are engraved into the roll at an angle that is less than 90 degrees.

14. The apparatus for applying a decorative design to a surface of claim 1 wherein the pattern is further engraved with a plurality of dots to create a halftone screen effect.

15. The apparatus of claim 14 wherein the dots vary in size and position within the pattern.

16. The apparatus of claim 1 wherein the pattern is a design selected from the group consisting of a brick design, stone design, flower design, and leaf design.

17. The apparatus of claim 1 wherein the roll is applied to a surface selected from the group consisting of sheetrock, wood, plaster, stucco, and concrete.

18. The apparatus of claim 1 wherein the roll is rolled over a surface that is painted or glazed.

19. An apparatus for applying a decorative design to a surface comprising:
a first roll having an outer cylindrically shaped surface formed of rubber;
a first pattern that is partially engraved into the rubber on the first roll such that the first pattern is raised on the outer surface of the first roll;
a second roll having an outer cylindrically shaped surface formed of rubber;
a second pattern that is partially engraved into the rubber on the second roll such that the second pattern is raised on the outer surface of the second roll;
wherein the second pattern on the second roll is orthogonal to the first pattern on the first roll;
wherein when the first roll is configured to be rolled onto a painted or glazed surface in a first direction such that the first pattern is transferred in ghost onto the surface; and
wherein the second roll is configured to be rolled onto a painted or glazed surface in a second direction that is perpendicular to the first direction and abuts and/or partially overlaps the image created by the first roll such that the second pattern is transferred in ghost onto the surface and there is no discernable line or seam between the images formed by the perpendicular and abutting and/or partially overlapping rows formed by the first roll and the second roll.

20. The apparatus of claim 19 wherein the first pattern and the second patterns are open-ended on both ends of their respective rolls.

21. The apparatus of claim 19 wherein the first pattern and the second patterns are close-ended on both ends of their respective rolls.

22. A method of applying a decorative pattern to a surface comprising the step of:
providing a roll having an outer cylindrically shaped surface formed of rubber, said roll having a pattern that is partially engraved into the rubber on the roll such that the pattern is raised on the outer surface of the roll; and
rolling the roll onto a surface in parallel and abutting and/or partially overlapping rows such that the pattern is transferred in ghost onto the surface and there is no discernable line or seam between the parallel and abutting and/or partially overlapping rows.

23. The method of claim 22, wherein the pattern is open-ended on both ends of the roll.

24. The method of claim 22 wherein the patters is close-ended on both ends of the roll.

25. The method of claim 22, further comprising the step of loading the roll onto a paint applicator comprising a handle such that the roll is rotatable on the paint applicator.

26. The method of claim 22, further comprising the step of loading the roll onto a cylinder comprising a handle such that the roll is rotatable on the cylinder.
